(19) United States
(12) Patent Application Publication
(10) Pub. No.: US 2023/0027217 A1
(43) Pub. Date: Jan. 26, 2023

(54) DYNAMIC INPUT DEVICE SURFACE TEXTURE COORDINATED WITH INFORMATION HANDLING SYSTEM OPERATIONS

(71) Applicant: Dell Products L.P., Round Rock, TX (US)

(72) Inventors: Deeder M. Aurongzeb, Austin, TX (US); Peng Lip Goh, Singapore (SG)

(73) Assignee: Dell Products L.P., Round Rock, TX (US)

(21) Appl. No.: 17/382,573

(22) Filed: Jul. 22, 2021

(51) Int. Cl. G06F 3/01; G06F 3/02

(52) U.S. Cl. CPC G06F 3/016; G06F 3/0227

(57) ABSTRACT

A dynamic texture device coupled to an information handling system input/output device adjusts texture at the input/output device surface based upon texture information generated at the information handling system, such as a walking surface in a virtual world defined by a gaming application. Texture at an elastic cover is adjusted by applying variable magnetic fields to a magnetorheological fluid (MRF) disposed under the elastic cover in a reservoir. For example, an electromagnet changes pole orientation and magnetic strength at MRF contained in a reservoir under a keyboard palm rest to simulate walking in a virtual world on different types of surfaces.

### BACKGROUND OF THE INVENTION

### Field of the Invention

The present invention relates in general to the field of information handling system input devices, and more particularly to a dynamic input device surface texture coordinated with information handling system operations.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Desktop information handling systems integrate processing components in a housing that interact with an end user through peripheral input/output devices, such as a peripheral display, a peripheral keyboard and a peripheral mouse. Portable information handling systems integrate processing components, a display and a power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In clamshell configuration, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility. Generally, portable information handling systems can also interact with end user through peripheral input/output devices similar to desktop information handling systems.

One popular use of information handling systems is to support gaming applications. Gaming applications generally create a virtual world in which an end user experiences challenges, such as racing a car or virtual combat, and interacts with the virtual world through input/output devices. For example, an end user might discharge weapons with a keyboard or mouse and view the virtual world through a display or a headset having virtual or augmented reality goggles. In addition, an end user may be provided with feedback from haptic type of devices, such as rotating offset weights that vibrate. Some input devices use accelerometers to detect orientation, such as turning a portable information handling system like a steering world to control a virtual car. Deep immersion of an end user in a virtual world with different types of sensors and haptic feedbacks provides the end user with a more realistic experience and augments the virtual world created by the gaming application. One type of feedback that is lacking in computer gaming virtual worlds is a texture feedback that an end user experiences with touch.

### SUMMARY OF THE INVENTION

Therefore, a need has arisen for a system and method which provides a texture feedback to an end user of an information handling system application.

In accordance with the present invention, a system and method are provided which substantially reduce the disadvantages and problems associated with previous methods and systems for providing a user of an application with feedback related to texture for an application executing on an information handling system. A magnetorheological fluid (MRF) disposed in a reservoir under an elastic surface of an input/output device and selectively exposed to varying magnetic fields provide texture feedback to an end user of an information handling system, such as for inputs made at an input device and/or outputs experienced at an output device.

More specifically, an information handling system processes information with processing components, such as a processor and memory, which execute instructions, such as an operating system and gaming application. The gaming application generates a virtual world that an end user experiences through input/output devices that allow the end user to see, touch and walk on virtual objects. Dynamic texture devices integrated with the input/output devices and located accessible to an end user touch provides feedback to the end user related to textures of the virtual world, such as a type of surface that the end user walks and runs on and the type of surfaces the end user touches. The dynamic texture device integrates MRF in a reservoir covered by an elastic surface and disposed proximate magnets that provide a selected magnetic field associated with a desired texture generated by MRF under the elastic surface. For example, electromagnets provide a dynamic magnetic field that changes texture of MRF based upon pole orientation and magnetic field strength responsive to conditions in a virtual world, thereby giving the end user texture feedback of the virtual world.

The present invention provides a number of important technical advantages. One example of an important technical advantage is that a virtual world created by an information handling system an interacted with through input/output devices has texture feedback provided to the end user by simulation of virtual conditions with changes in texture at the input/output devices. MRF subjected to magnetic fields changes its stiffness and shape based upon the type of magnetic field generated in proximity to the MRF. An end user is provided with an enhanced virtual experience that simulates walking, running, wind, handling and touching of objects, and other virtual interactions.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exploded perspective view of an information handling system having plural input/output devices configured with a dynamic texture device;

FIG. 2 depicts a perspective view of a keyboard having a dynamic texture device integrated in a palm rest;

FIG. 3 depicts a perspective sectional view of the dynamic texture device integrated in a keyboard palm rest;

FIG. 4 depicts a side sectional view of the dynamic texture device integrated in the keyboard palm rest;

FIGS. 5A and 5B depict a side sectional view of magnetorheological fluid (MRF) in a reservoir having variable texture based upon application of variable magnetic fields; and

FIG. 6 depicts a block diagram of a system for managing texture at an information handling system input/output device.

### DETAILED DESCRIPTION

Magnetorheological fluid (MRF) disposed in a reservoir at an input/output device of an information handling system changes texture by application of variable magnetic fields to simulate conditions in a virtual world of a gaming application, such as a walking surface. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

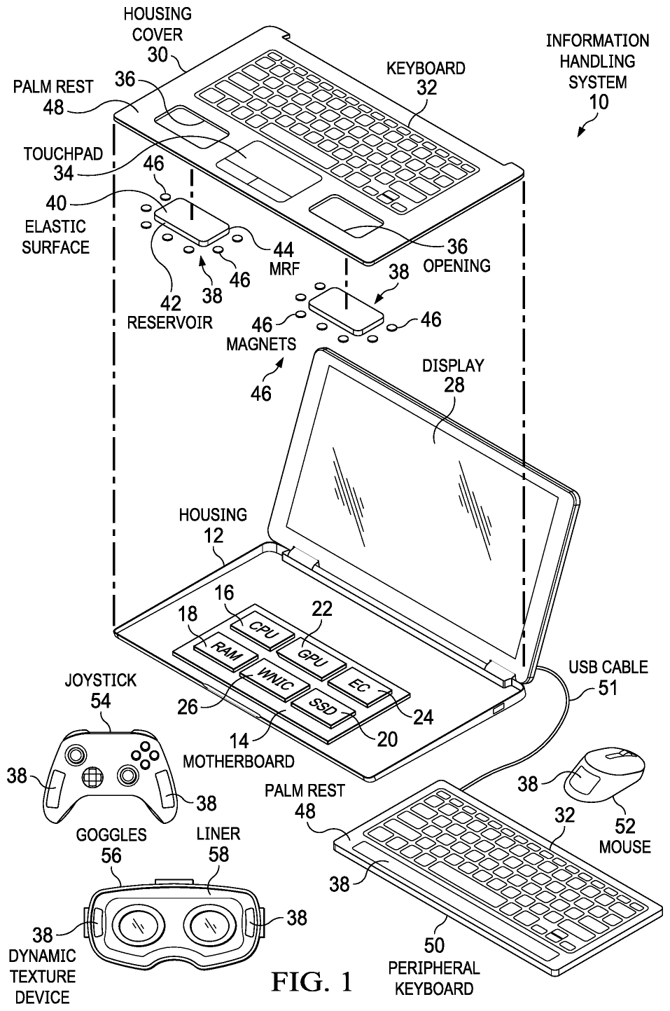

Referring now to FIG. 1, an exploded perspective view depicts an information handling system 10 having plural input/output devices configured with a dynamic texture device 38. In the example embodiment, information handling system 10 is built in a portable housing 12 that contains processing components that cooperate to process information. A motherboard 14 couples to housing 12 and interfaces the processing components with integrated wirelines. A central processing unit (CPU) 16 executes instructions to process information and interfaces with a random access memory (RAM) 18 that stores the instructions and information. A solid state drive (SSD) 20 or other persistent storage provides non-transient memory that stores the instructions and information during power down, such as an operating system and applications that execute on CPU 16. A graphics processing unit (GPU) 22 interfaces with CPU 16 to further process information to generate pixel values that define visual images for presentation at a display 28. An embedded controller 24 manages operating conditions of the processing components, such as application of power and maintaining thermal constraints, and also manages interactions with input/output devices, such as an integrated keyboard 32, a peripheral keyboard 50, a mouse 52, touchscreen display 28, joystick 54, goggles 56 or other devices. A wireless network interface card (WNIC) supports wireless communication with external networks, such as WiFi, and peripheral devices, such as through Bluetooth.

In the example embodiment, a housing cover 30 couples over housing 12 to cover the processing components and to support a keyboard 32 that accepts end user key inputs. A touchpad 34 accepts touch inputs of the end user to control a pointer icon on display 28, similar to a mouse. Housing cover 30 includes an opening 36 on each side of touchpad 34 sized to fit a dynamic texture device 38 exposed at a palm rest 48 of keyboard 32. Dynamic texture device 38 has an elastic surface 40, such as a silicon elastomer sheet, that covers a reservoir 42 having a magnetorheological fluid (MRF) 44 that supports against the underside of elastic surface 40. MRF 44 is, for instance, an oil-based smart liquid having fine iron particles so that the fluid's viscosity and yield/shear stress are manipulated by changes in magnetic flux. In the absence of a magnetic field, MRF 44 has a soft feel similar to a cushion. As different types of magnetic fields are applied, MRF 44 dynamically changes in hardness and texture with a rapid response to simulate a texture at elastic surface. Magnets 46 are disposed at the exterior of reservoir 42 and configured to adjust their magnetic field strength and pole orientation to adapt MRF 44 to a desired texture. For instance, magnets 46 are electromagnets that generate a magnetic field with passage of current around a ferromagnetic material so that the magnetic field strength and pole orientation are controllable by adjusting the amount and direction of current applied. As an alternative, electropermanent magnets may be used with different pole orientations to generate magnetic fields. Electromagnets have a greater flexibility in the type of magnetic field generated by changing current levels and direction but draw power during generation of the magnetic fields; in contrast, electropermanent magnets switch a given magnetic field on and off with a brief application of current for less power draw, but offer only on and off settings with one pole orientation per magnet. In the example embodiment, magnets 46 may deploy at all sides of and under reservoir 42 to achieve desired textures.

Magnets 46 are controlled, for example, with firmware that executes on embedded controller 24 based upon textures generated by a virtual world of a gaming application executing on CPU 16. In the example embodiment, dynamic texture device 38 integrates in a variety of input/output devices to receive texture commands from embedded controller 24. For instance, a dynamic texture device 38 is disposed in an upper surface of a mouse 52, a palm rest 48 of peripheral keyboard 50, an upper surface of a joystick 54 and a face liner 58 of virtual reality or augmented reality goggles 56. Control of texture may be communicated to peripheral devices through a cable, such as a USB cable 51 or wireless signals from WNIC 26, such as with Bluetooth. The simulated texture may include walking on a virtual surface, such as concrete or sand, touching a virtual object, such as metal or concrete, and wind against a user face. Dynamic texture output provided with dynamic and different magnetic fields from different magnets 46 provides application designers with flexibility to enhance virtual worlds in a wide variety of ways. For example, cycling between magnet poles might create an earthquake effect while changing current levels from high to low provide a diminishing aftershock effect.

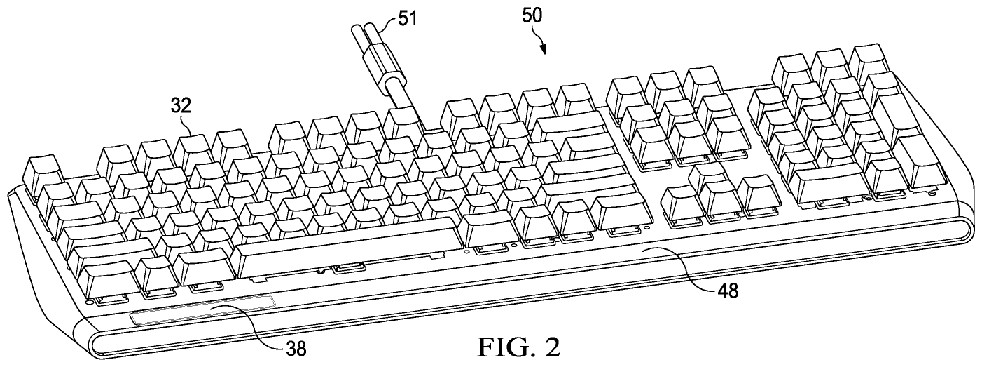

Referring now to FIG. 2, a perspective view depicts a peripheral keyboard 50 having a dynamic texture device 38 integrated in a palm rest 48. Peripheral keyboard 50 includes a keyboard 32 in a housing separate from an information handling system that communicates through a USB cable 51 or other communication medium, such as a Bluetooth interface. Commands from the information handling system adjust the texture at dynamic texture device 38, such as by changing the magnetic field applied at MRF contained in a reservoir of dynamic texture device 38. In one embodiment, dynamic texture device 38 has adjustments applied only when peripheral keyboard 50 is the source of an input that generated the texture output. Although the example embodiment has dynamic texture device 38 only at an area typically where a palm rests, an alternative embodiment may extend along the length of palm rest 48 and any other location where an end user may touch.

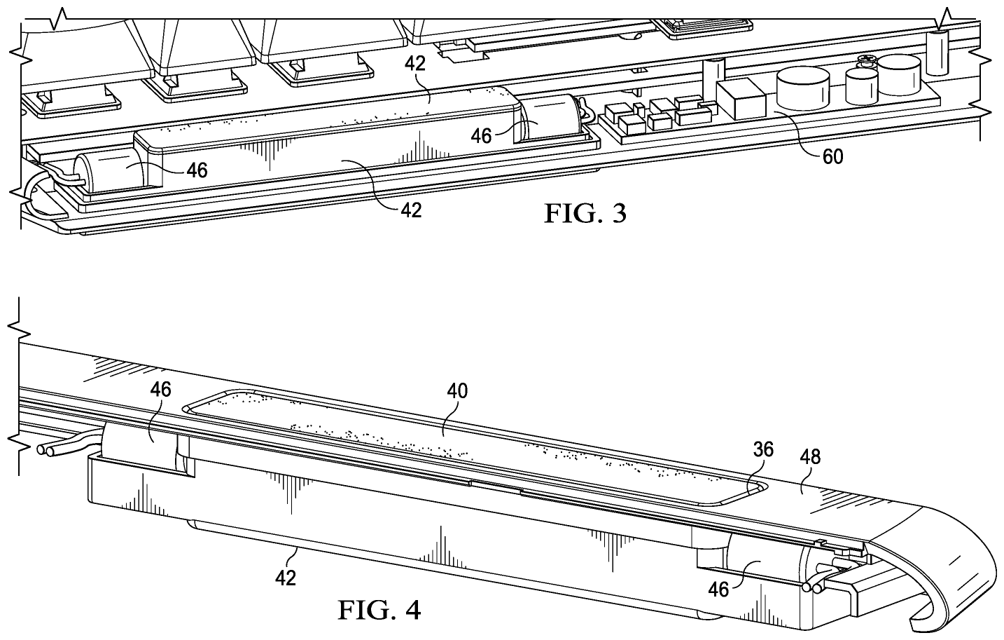

Referring now to FIG. 3, a perspective sectional view depicts the dynamic texture device 38 integrated in a keyboard palm rest 48. The example embodiment has an elastic surface 40 coupled over a reservoir 42 that contains MRF. A magnet 46 couples at each opposing end of reservoir 42 and interfaces with a power board 60 that selectively applies current to generate magnetic fields. In the example embodiment, magnets 46 are electromagnets that generate a magnetic pole orientation based upon the direction of current flow and generate magnetic fields of variable strength based upon the amount of current. In an alternative embodiment, magnets 46 may be electropermanent magnets that turn a magnetic field on and off with a brief application of current. Although the example embodiment has magnets 46 at opposing sides of MRF reservoir 42, alternative embodiments may deploy additional magnets in different positions.

Referring now to FIG. 4, a side sectional view depicts the dynamic texture device 38 integrated in the keyboard palm rest 48. An opening 36 formed in palm rest 48 is sized to accept elastic surface 40 so that MRF in reservoir 42 is disposed against the elastic material where an end user can feel changes in texture as magnets 46 adjusts the applied magnetic field.

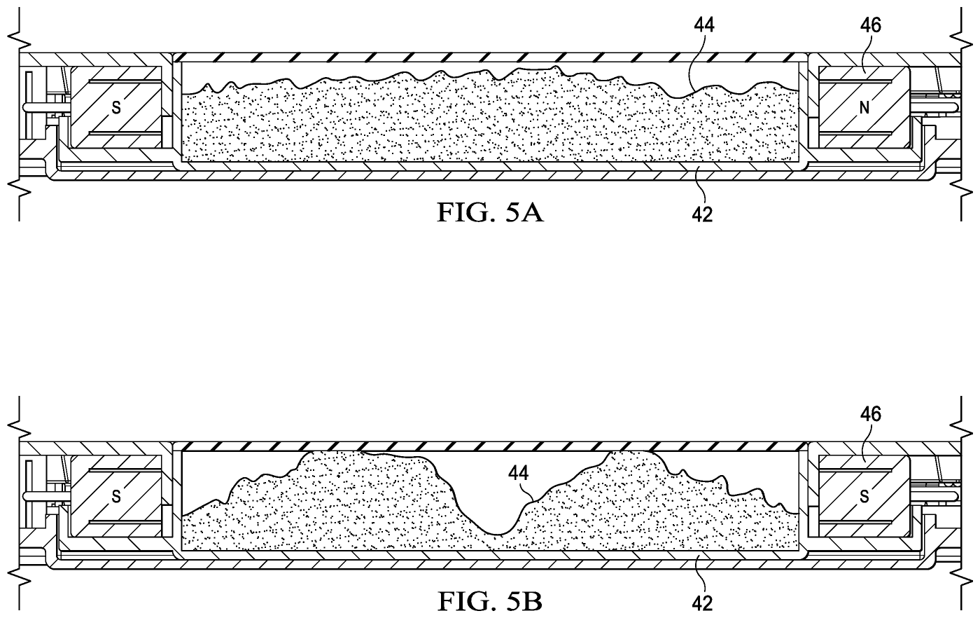

Referring now to FIGS. 5A and 5B, a side sectional view depicts magnetorheological fluid (MRF) 44 in a reservoir 42 having variable texture based upon application of variable magnetic fields. When no magnetic field is present, MRF 44 has the texture of an oil captured with an elastic cover to offer a cushion for an end user palm. FIG. 5A depicts magnetic fields of opposing poles from magnets 46 at opposite sides of reservoir 42, resulting in a stiffening of MRF 44 as the ferromagnetic particles interact to define a rough but generally level surface under the elastic surface. FIG. 5B depicts magnetic fields of the same pole from magnets 46 at opposite sides of reservoir 42, resulting in a stiffening of MRF 44 as the ferromagnetic particles interact to define a rough and uneven surface having a recessed central region. The amount of magnetic flux impacts the degree of stiffness of MRF 44 and the shape exposed at the elastic surface to provide a developer with an array of textures available to support a more realistic representation of a virtual world, such as may be created by a gaming application.

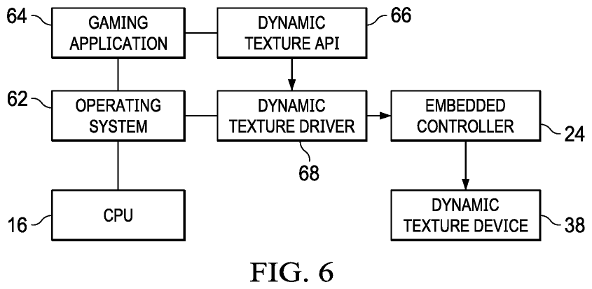

Referring now to FIG. 6, a block diagram depicts a system for managing texture at an information handling system input/output device. In the example embodiment, CPU 16 executes an operating system 62 that manages interactions with physical devices, such as with communication through embedded controller 24. A gaming application 64 executes over operating system 62 to create a virtual world that an end user interacts with through input/output devices, such as the example keyboard, mouse, joystick, and goggles shown in FIG. 1. Gaming application 64 accesses dynamic texture settings through a dynamic texture application programming interface (API 66), which in turn communicates commands through a dynamic texture driver 68 of operating system 62 to embedded controller 24 so that current commands are provided to dynamic texture device 38 for driving variations in magnetic flux.

Although the present invention has been described in detail, it should be understood that various changes, substitutions and alterations can be made hereto without departing from the spirit and scope of the invention as defined by the appended claims.

1. An information handling system faults, the system comprising:
a housing;
a processor disposed in the housing and operable to execute instructions that process information;
a memory disposed in the housing and interfaced with the process to store the instructions and information;
a persistent storage device interfaced with the processor and having non-transient memory storing an application that defines a virtual environment for presentation to an end user;
an embedded controller disposed in the housing and interfaced with the processor, the embedded controller operable to manage operating conditions within the housing and interactions of the processor with input devices;
an input/output device interface with processor and operable to communicate information between the processor and an end user; and
a dynamic texture device integrated with the input/output device aligned to contact the end user when interaction with input/output device, the dynamic texture device interfaced with the processor to dynamically adjust a surface texture of the input/output device in response to one or more predetermined conditions, the dynamic texture device having a reservoir covered by an elastic material, the reservoir containing a magnetorheological fluid (MRF), and having one or more magnets proximate the MRF, the magnets operable to adjust a magnetic field applied to the MRF to dynamically adjust the surface texture under the elastic material;
wherein the application dynamically commands changes to the dynamic texture device based upon the virtual environment.

2. The information handling system of claim 1 wherein:
the input/output device comprises a keyboard having a palm rest; and
the dynamic texture device integrates in the palm rest.

3. The information handling system of claim 1 wherein:
the input/output device comprises a joystick; and
the dynamic texture device integrates in an outer surface of the joystick.

4. The information handling system of claim 1 wherein:
the input/output device comprise a mouse; and
the dynamic texture device integrates in an upper surface of the mouse.

5. The information handling system of claim 1 wherein:
the input/output device comprises eye goggles; and
the dynamic texture device integrates in an inner liner of the eye goggles.

6. The information handling system of claim 1 wherein the one or more magnets comprises plural electromagnets operable to selectively apply a north magnetic field towards the MRF, a south magnetic field towards the MRF and no magnetic field.

7. The information handling system of claim 1 wherein the one or more magnets comprise electropermanent magnets.

8. The information handling system of claim 1 further comprising:
a gaming application operable to present a virtual world; and
the predetermined condition comprises an avatar walking on a rough surface in the virtual world.

9. The information handling system of claim 8 further comprising:
a driver executing on the processor and associated with the input/output device and operable to command surface textures to the embedded controller; and
the embedded controller communicates the command to the one or more magnets.

10. A method for outputting surface texture information, the method comprising:
coupling a dynamic texture device to an input/output device;
generating texture output information with an application executing on an information handling system, the application presenting a virtual environment to an end user, the texture output information created as part of the virtual environment and dynamically changing with the virtual environment;
in response to the generating texture output information, commanding one or more magnets to adjust a magnetic field applied to a magnetorheological fluid (MRF) within the dynamic texture device; and
presenting the texture output with the MRF acting against an elastic surface of the dynamic texture output.

11. The method of claim 10 wherein:
the texture output information comprises terrain of a gaming application virtual world; and
the presenting comprises simulating walking on the terrain.

12. The method of claim 11 wherein the coupling a dynamic texture device further comprises coupling the dynamic texture device at a keyboard palm rest.

13. The method of claim 11 wherein the coupling a dynamic texture device further comprises coupling the dynamic texture device at a joystick housing.

14. The method of claim 11 wherein the coupling a dynamic texture device further comprises coupling the dynamic texture device at a mouse housing.

15. The method of claim 10 wherein:
the texture output information comprises wind of a gaming application virtual world; and
the presenting comprises simulating the wind with the texture output device at a goggles face liner.

16. The method of claim 10 wherein the commanding one or more magnets further comprises:
selectively applying a first magnetic field having the same pole with both first and second magnets;
selectively applying a second magnetic field having opposite poles with the first and second magnets; and
selectively applying substantially no magnetic field from both the first and second magnets.

17. The method of claim 10 wherein the one or more magnets comprise an electromagnet interfaced with a power source operable to apply a variable current level to generate a variable strength magnetic field.

18. A keyboard comprising:
plural keys operable to accept key inputs by an end user;
a palm rest positioned to support an end user palm during key inputs;
a reservoir coupled to the keyboard under the palm rest;
magnetorheological fluid (MRF) disposed in the reservoir;
an elastic cover coupled over the reservoir and MRF;
one or more magnets disposed in the keyboard proximate the reservoir and operable to apply a magnetic field of variable strength and pole orientation to the MRF;
a processing resource; and
a non-transient memory interfaced with the processing resource and storing instructions that when executed on the processing resource dynamically change the magnetic field to imitate a virtual environment presented by an information handling system.

19. The keyboard of claim 18 further comprising:
at least one of the one or more magnets is an electromagnet; and
a power source interfaced with the at least one of the one or more magnets and operable to selectively apply current to adjust the magnet pole orientation and magnetic field strength.

20. The keyboard of claim 19 wherein the at least one magnet comprises first and second electropermanent magnets having opposite poles directed towards the MRF.
